(19) United States
(12) Patent Application Publication
(10) Pub. No.: US 2011/0044072 A1
(43) Pub. Date: Feb. 24, 2011

(54) BACKLIGHT MODULE AND LIGHT GUIDE UNIT

(75) Inventors: Han-Wen Tsai, Hsin-Chu (TW); Fu-Ming Chuang, Hsin-Chu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: CORETRONIC CORPORATION, Hsin-Chu (TW)

(21) Appl. No.: 12/814,502

(22) Filed: Jun. 14, 2010

(30) Foreign Application Priority Data
Aug. 21, 2009 (TW) 98215524

(51) Int. Cl. F21V 7/04; F21V 7/22

(52) U.S. Cl. 362/606; 362/609

(57) ABSTRACT

A light guide unit includes a light transmissive base, a plurality of scattering particles, and a plurality of reflective particles. The light transmissive base includes a scattering region and a reflective region. The scattering region has a light emitting surface, a boundary surface, and a light incident surface. The reflective region includes a lamp cover portion and a bottom portion. The lamp cover portion is disposed beside the light incident surface. The bottom portion is disposed at one side of the boundary surface and connected with the scattering region through the boundary surface. The light transmissive base is integrally formed. The scattering particles are doped in the scattering region, and the reflective particles are doped in the reflective region. The number density of the scattering particles in the scattering region is less than that of the reflective particles in the reflective region. A backlight module is also provided.

### CROSS-REFERENCE TO RELATED APPLICATION

This application claims the priority benefit of Taiwan application serial no. 98215524, filed on Aug. 21, 2009. The entirety of the above-mentioned patent application is hereby incorporated by reference herein and made a part of this specification.

### BACKGROUND OF THE INVENTION

1. Field of Invention

The invention relates to a light source module and an optical device, and more particularly, to a backlight module and a light guide unit.

2. Description of Related Art

With rapid progress in display techniques, the flat panel display has become the mainstream among various displays and replaced the cathode ray tube (CRT). Among various flat panel displays, the liquid crystal display (LCD) has been deeply favored by the consumers. Generally, the LCD is mainly formed by the backlight module and the liquid crystal panel. Because the liquid crystal panel does not emit light by itself, the backlight module is used to generate the backlight source.

In general, the backlight module is categorized into a direct type backlight module and a side type backlight module. The side type backlight module mainly includes a light guide plate, a light source, and a reflective plate. The light guide plate has a first surface, a second surface opposite to the first surface, and a light incident surface connecting the first surface and the second surface. The light source is disposed beside the light incident surface, the reflective plate is disposed on the second surface, and the first surface is a light emitting surface. Usually, there is an air gap existing between the second surface and the reflective plate, so that the light emitted by the light source may be totally reflected in the light guide plate. However, when the light guide plate or the reflective plate is deformed, the abnormal attachment of the light guide plate and the reflective plate may occur easily, and reduce the uniformity of the surface light source provided by the backlight module.

Moreover, the light guide plate and the reflective plate are manufactured independently. Accordingly, the assembly of the light guide plate and the reflective plate is required. However, when the light guide plate and the reflective plate are assembled, the surface cleanness of the light guide plate and the reflective plate is a matter needing attention. If there are dusts or pollutants on surfaces of the light guide plate and the reflective plate, an ill effect may easily affect the uniformity of the surface light source.

Moreover, a reflective lamp cover is disposed beside the light incident surface to cover the light source and reflect the light emitted by the light source to the light incident surface. In order to obtain the surface light source having the good quality, the alignment is required while the reflective lamp cover, the light guide plate, and the reflective plate are assembled because the reflective lamp cover, the light guide plate, and the reflective plate are manufactured independently. However, the alignment process costs a long time on manufacturing and reduces the yield.

Furthermore, the second surface of the light guide plate usually has optical micro-structures capable of destroying the total internal reflection of the light on the surface of the light guide plate. However, a suitable distribution design by an engineer having sufficient experience is necessary for the optical micro-structures to obtain the uniform surface light source provided by the backlight module, wherein designing the suitable distribution costs the company a lot of research funds and a lot of research time.

In addition, Taiwan patent publication Nos. 200728862 and 20064147, Taiwan patent No. M351426, and U.S. Pat. No. 6,426,763 also disclose various light guide plates and other optical devices in the backlight modules.

### SUMMARY OF THE INVENTION

The invention provides a backlight module capable of providing uniform emitting light. The backlight module is easy to design and manufacture and has high yields and low cost.

The invention provides a light guide unit capable of guiding uniform emitting light. The light guide unit is easy to design and manufacture and has high yields and low cost.

Other objects and advantages of the invention may be further understood by referring to the technical features broadly embodied and described as follows.

In order to achieve at least one of the above advantages, an embodiment of the invention provides a backlight module including a light transmissive base, at least one light emitting device, a plurality of scattering particles, and a plurality of reflective particles. The light transmissive base includes a scattering region and a reflective region. The scattering region has a light emitting surface, a boundary surface opposite to the light emitting surface, and a light incident surface connecting the light emitting surface and the boundary surface. The reflective region includes a lamp cover portion and a bottom portion. The lamp cover portion is disposed beside the light incident surface. The bottom portion is disposed at one side of the boundary surface and connected with the scattering region through the boundary surface. The light transmissive base is integrally formed. The at least one light emitting device is disposed between the light emitting surface and the lamp cover portion and capable of emitting a light beam. The scattering particles are doped in the scattering region, and the reflective particles are doped in the reflective region. A first number density of the scattering particles in the scattering region is less than a second number density of the reflective particles in the reflective region, so that the scattering region is capable of being passed through by the light beam and scattering the light beam, and the reflective region is capable of reflecting the light beam.

Another embodiment of the invention provides a light guide unit including the light transmissive base, the scattering particles, and the reflective particles. The relative positions, the detailed structures, and the configurations of the light transmissive base, the scattering particles, and the reflective particles are the same as the above description. A containing space exists between the light incident surface and the lamp cover portion. The scattering region is capable of being passed through by the light beam and scattering the light beam, and the reflective region is capable of reflecting the light beam.

In the backlight module and the light guide unit according to the embodiments of the invention, the scattering region and the bottom portion of the reflective region are integrally formed. Accordingly, the light uniformity of the embodiments in the invention is not reduced due to the abnormal attachment of the light guide plate and the reflective plate. The abnormal attachment occurs in the related art and is caused by the deformation of the light guide plate or the reflective plate in the backlight module. Therefore, the light guide unit may guide light having uniform brightness on the light emitting surface, and the backlight module may provide a uniform surface light source.

Moreover, the scattering region and the bottom portion are integrally formed. Accordingly, the optical quality of the embodiments in the invention is not reduced due to the poor surface cleanness while the light guide plate and the reflective plate are assembled in the related art. Therefore, in the embodiments of the invention, the backlight module and the light guide unit have good optical quality and high yield.

Furthermore, compared with the light guide plate, the reflective plate, and the reflective lamp cover in the related art, wherein the optical quality is reduced due to the error generated when the light guide plate, the reflective plate, and the reflective lamp are aligned, in the embodiments of the invention, the scattering region and the reflective region are integrally formed, and the lamp cover portion and the bottom portion are integrally formed. Accordingly, while the light transmissive base has been integrally formed, each of the scattering region, the lamp cover portion, and the bottom portion is disposed in the suitable position. Therefore, the backlight module and the light guide unit of the embodiments of the invention have good optical quality and high yield.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic cross-sectional view of a backlight module according to an embodiment of the invention.

FIG. 2 is a magnified view of area A in FIG. 1.

FIG. 3 and FIG. 4 are other configurations of the light incident surface in FIG. 1.

FIG. 5 is a schematic cross-sectional view of a backlight module according to another embodiment of the invention.

FIG. 6A is a schematic three-dimensional view of a backlight module according to another embodiment of the invention.

FIG. 6B is a schematic cross-sectional view illustrating the backlight module of FIG. 6A along line I-I.

FIG. 7A is a schematic three-dimensional view of a backlight module according to another embodiment of the invention.

FIG. 7B is a schematic cross-sectional view illustrating the backlight module of FIG. 7A along line II-II.

FIG. 8 illustrates a schematic cross-sectional view of a backlight module according to another embodiment of the invention.

### DESCRIPTION OF EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

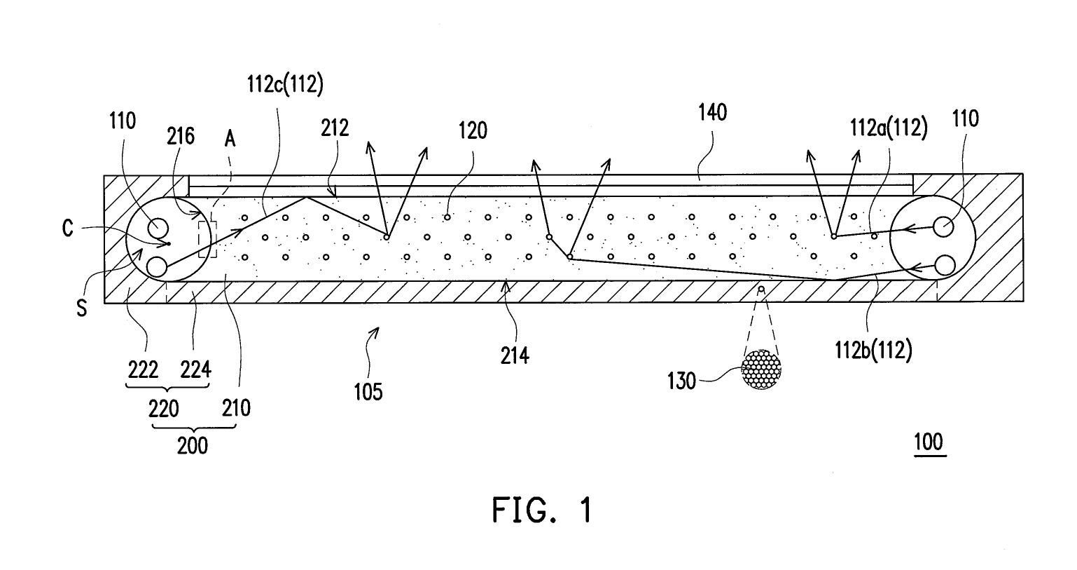

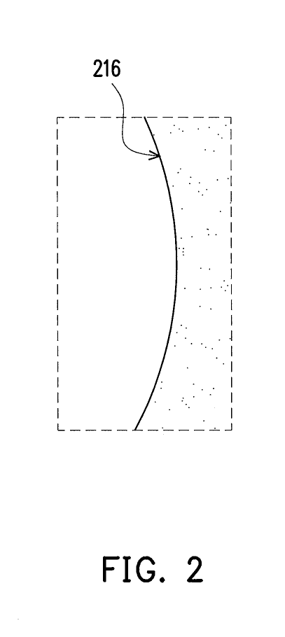

Referring to FIG. 1 and FIG. 2, the backlight module 100 of the embodiment includes a light guide unit 105 and at least one light emitting device 110 (the plurality of light emitting devices 110 is exemplary in FIG. 1). The light guide unit 105 includes a light transmissive base 200, a plurality of scattering particles 120, and a plurality of reflective particles 130. The light transmissive base 200 includes a scattering region 210 and a reflective region 220. The scattering region 210 has a light emitting surface 212, a boundary surface 214 opposite to the light emitting surface 212, and a light incident surface 216 connecting the light emitting surface 212 and the boundary surface 214 (two opposite light incident surfaces 216 are exemplary in FIG. 1). The reflective region 220 includes a lamp cover portion 222 and a bottom portion 224. The lamp cover portion 222 is disposed beside the light incident surface 216. The bottom portion 224 is disposed at one side of the boundary surface 214 and connected with the scattering region 210 through the boundary surface 214. In the embodiment, the material of the reflective region 220 includes polymethyl methacrylate (PMMA), other plastics, or other polymers.

The light emitting devices 110 are disposed between the light incident surface 216 and the lamp cover portion 222 and capable of emitting a light beam 112. In the embodiment, the light emitting devices 110 is a cold cathode fluorescent lamp (CCFL). However, in other embodiments, the light emitting device may be a light emitting diode (LED) or other suitable light emitting devices.

The scattering particles 120 are doped in the scattering region 210, and the reflective particles 130 are doped in the reflective region 220. In the embodiment, the material of the reflective particles 130 includes silver, gold, or other materials having high reflectivity. Moreover, the light transmissive base 200 is integrally formed. In other words, the scattering region 210 and the reflective region 220 are integrally formed, and the lamp cover portion 222 and the bottom portion 224 are also integrally formed. Specifically, the scattering particles 120, the reflective particles 130, and the light transmissive base 200 may be simultaneously formed through the dual color extrusion or the dual color injection molding, or be integrally formed through other dual color molding.

A first number density of the scattering particles 120 in the scattering region 210 is less than a second number density of the reflective particles 130 in the reflective region 220, so that the scattering region 210 is capable of being passed through by the light beam 112 and scattering the light beam 112, and the reflective region 220 is capable of reflecting the light beam 112. The volume percentage of the scattering particles 120 relative to the scattering region 210 ranges from 0.05% to 5%, so that the scattering region 210 has a high efficiency of light transmitting and light guiding, and further has a good effect for light scattering. Specifically, a part of the light beam 112a emitted by the light emitting device 110 is scattered by the scattering particles 120, and then the part of the light beam 120a is emitted out of the light transmissive base 200 through the light emitting surface 212. Moreover, another part of the light beam 112b emitted by the light emitting device 110 is reflected to the scattering particles 120 by the bottom portion 224 at least once, and then the part of the light beam 120b is emitted out of the light transmissive base 200 through the light emitting surface 212. Furthermore, another part of light beam 112c emitted by the light emitting device 110 is totally reflected to the scattering particles 120 by the light emitting surface 212 at least once, and then the part of the light beam 120c is emitted out of the light transmissive base 200 through the light emitting surface 212.

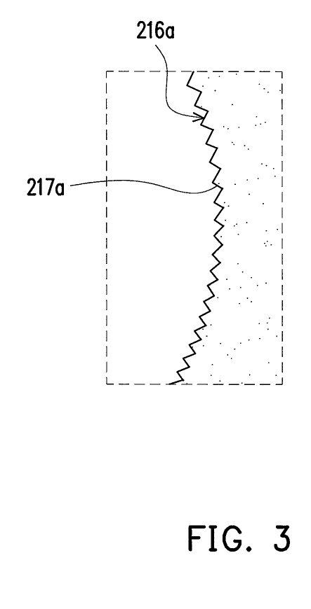

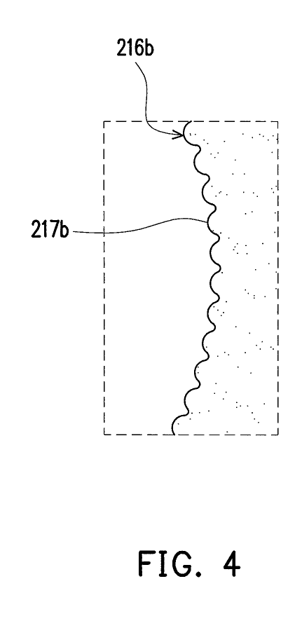

In the embodiment, a containing space S exists between the lamp cover portion 222 and the light incident surface 216, and the light emitting device 110 is disposed in the containing space S, wherein the lamp cover portion 222 is capable of reflecting the light beam 112 to the light incident surface 216. The light incident surface 216 is a concave surface. In the embodiment, the curvature center C of the light incident surface 216 may be adjacent to the position between the two neighboring light emitting devices 110, so that the incident angle of the light beam 112 emitted by the light emitting device 110 is smaller when the light beam 112 enters into the light incident surface 216, thus reduces the percentage of the light beam 112 reflected by the light incident surface 216. In the embodiment, the light incident surface 216 is a smooth concave surface as shown in FIG. 2. However, in other embodiment, the light incident surface 216a may have surface micro-structures 217a, wherein the surface micro-structures 217a is serration shaped micro-structures as shown in FIG. 3. Alternatively, in other embodiments, the surface micro-structures 217b of the light incident surface 216b may also include smooth convex surfaces and concave surfaces, as shown in FIG. 4.

In the backlight module 100 and the light guide unit 105 of the embodiment, the scattering region 210 and the bottom portion 224 of the reflective region 220 are integrally formed, and no air gap is between the scattering region 210 and the bottom portion 224. Accordingly, the light uniformity of the embodiment is not reduced due to the abnormal attachment of the light guide plate and the reflective plate in the backlight module, wherein the abnormal attachment is caused by the deformation of the light guide plate or the reflective plate in the related art. Therefore, the light guide unit 105 of the embodiment may guide light having uniform brightness on the light emitting surface 212, and the backlight module 100 may provide a uniform surface light source.

Moreover, the scattering region 210 and the bottom portion 224 of the embodiment are integrally formed. Accordingly, the light quality of the embodiment is not reduced due to the poor surface cleanness while the light guide plate and the reflective plate are assembled in the related art. Therefore, in the embodiment of the invention, the backlight module 100 and the light guide unit 105 have good optical quality and high yield.

Furthermore, compared with the light guide plate, the reflective plate, and the reflective lamp cover in the related art, wherein the optical quality is reduced due to the error generated when the light guide plate, the reflective plate, and the reflective lamp are aligned, in the embodiment, the scattering region 210 and the reflective region 220 are integrally formed, and the lamp cover portion 222 and the bottom portion 224 are integrally formed. Accordingly, while the light transmissive base 200 has been integrally formed, each of the scattering region 210, the lamp cover portion 222, and the bottom portion 224 is disposed in the suitable position. Therefore, the backlight module 100 and the light guide unit 105 of the embodiment have good optical quality and high yield.

In the embodiment, the scattering particles 120 are substantially uniformly distributed in the scattering region 210, and the reflective particles 130 are substantially uniformly distributed in the reflective region 220. In the conventional light guide plate, the suitable distribution design of the optical micro-structures on the surface of the light guide plate by an engineer having sufficient experience is necessary to obtain the uniform surface light source. However, designing the suitable distribution costs the company a lot of research funds and a lot of research time. Compared with the conventional light guide plate, the light guide unit 105 and the backlight module 100 of the embodiment are simply required to appropriately adjust the number densities of the scattering particles 120 and the reflective particles 130, and then the uniform surface light source is generated. Accordingly, the design cost and the design time of the light guide unit 105 and the backlight module 100 of the embodiment are lower, and the light guide unit 105 and the backlight module 100 of the embodiment have shorter time from production to market.

In order to enhance the brightness and the uniformity of the surface light source, the backlight module 100 further includes an optical film set 140 disposed on the light emitting surface 212 of the scattering region 210 in the embodiment, wherein the optical film set 140 includes at least one of a diffusion film, a brightness enhancement film, and a prism film. The diffusion film may increase the uniformity of the surface light source, and the brightness enhancement film and the prism film may increase the brightness of the surface light source.

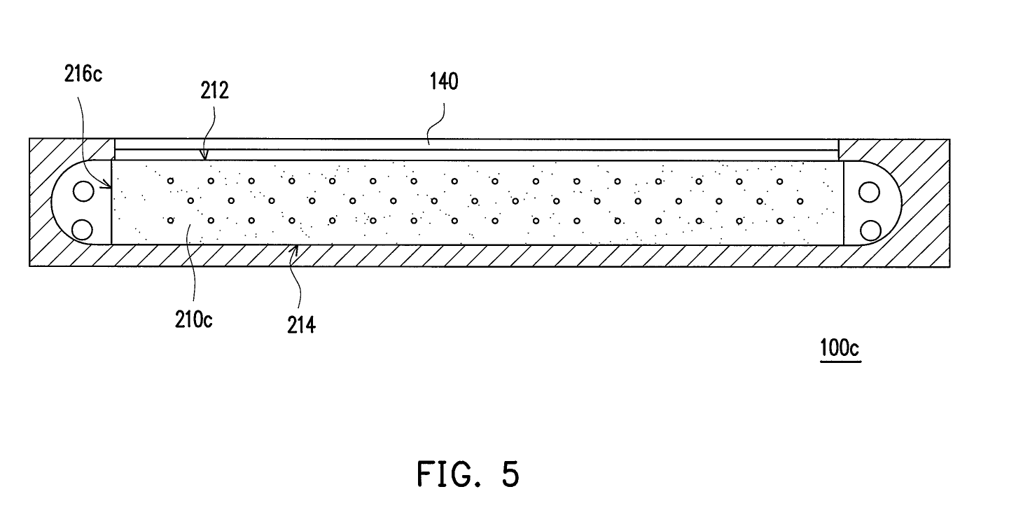

Referring to FIG. 5, the backlight module 100c of the embodiment is similar to the above-described backlight module 100 as shown in FIG. 1, and the difference between the backlight module 100c and the backlight module 100 is that the light incident surface 216c of the scattering region 210c is a plane surface in the embodiment. However, in other embodiments, the light incident surface 216c may be a plane surface having micro-structures or a curved convex surface, and the invention is not limited here.

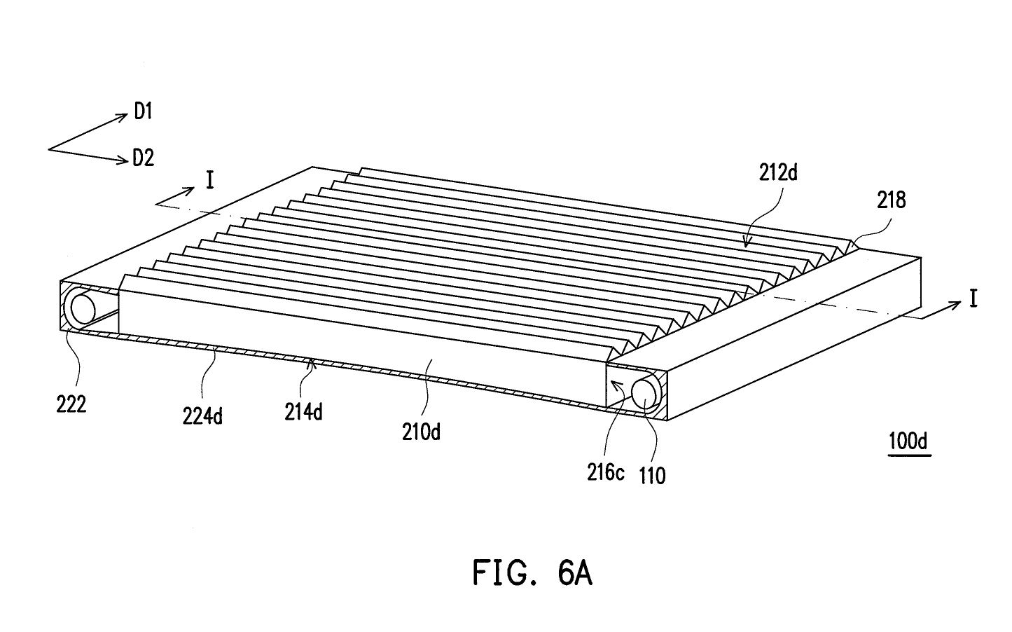

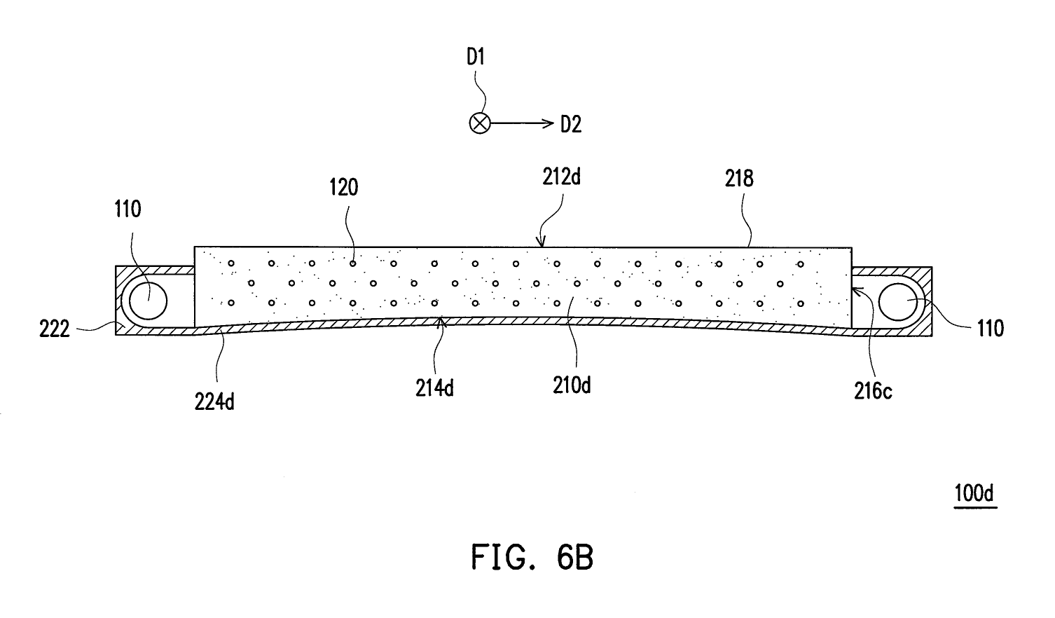

Referring to FIG. 6A and FIG. 6B, the backlight module 100d of the embodiment is similar to the above-described backlight module 100c as shown in FIG. 5, the difference between the backlight module 100d and the backlight module 100c is described as follows. In the backlight module 100d of the embodiment, the scattering region 210d includes a plurality of rod-shaped prism structures 218 disposed on the light emitting surface 212d. In the embodiment, each of the rod-shaped prism structures 218 extends from one side adjacent to the light incident surface 216c to a place away from the light incident surface 216c. For example, the extending direction of each of the rod-shaped prism structures 218 is substantially perpendicular to the light incident surface 216c. That is, each of the rod-shaped prism structures 218 extends along the direction D2 in FIG. 6A, and the rod-shaped prism structures 218 are arranged along the direction D1 in FIG. 6A, wherein the direction D2 is substantially perpendicular to the light incident surface 216c, and the direction D1 is perpendicular to the direction D2. The rod-shaped prism structures 218 may reduce the dispersion angle of the light beam emitted from the light emitting surface 212d, and make the backlight module 100d provide a surface light source having higher brightness.

Moreover, the boundary surface 214d is a curved surface in the embodiment. Specifically, the boundary surface 214d protrudes toward the light emitting surface 212d. Furthermore, the boundary surface 214d may be curved in the direction substantially perpendicular to the light incident surface 216c. Moreover, the bottom portion 224 may be curved with the boundary surface 214d. Accordingly, the uniformity of the surface light source provided by the backlight module 100d may further be enhanced, and a darker being in the intermediate zone of the surface light source may not occur or be improved. However, the boundary surface 214d may protrude toward the direction away from the light emitting surface 212d in other embodiments.

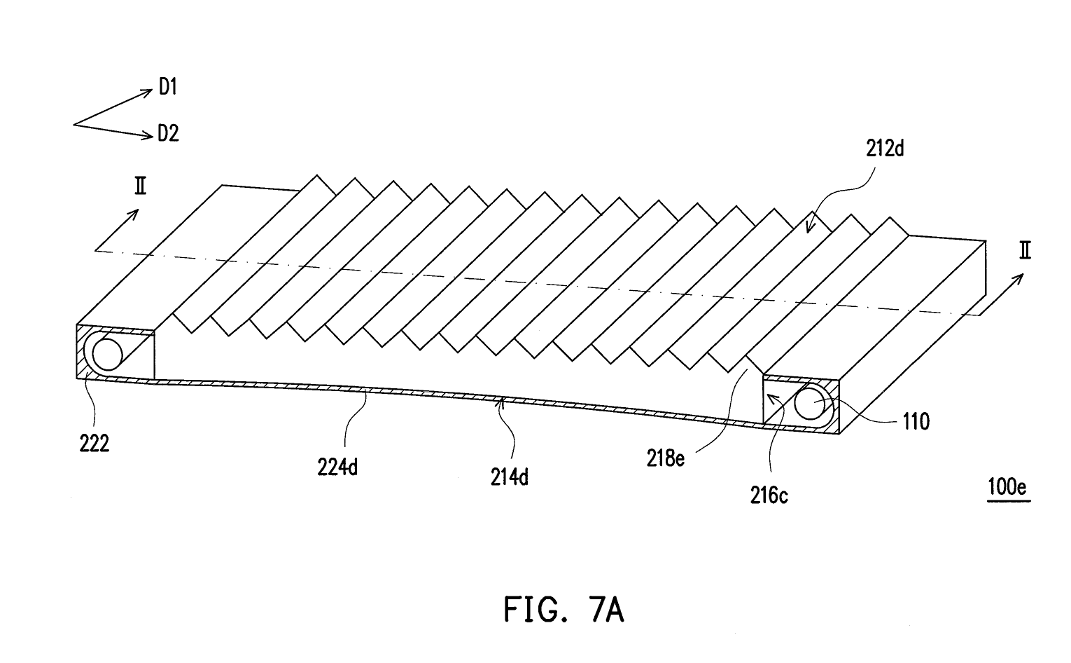

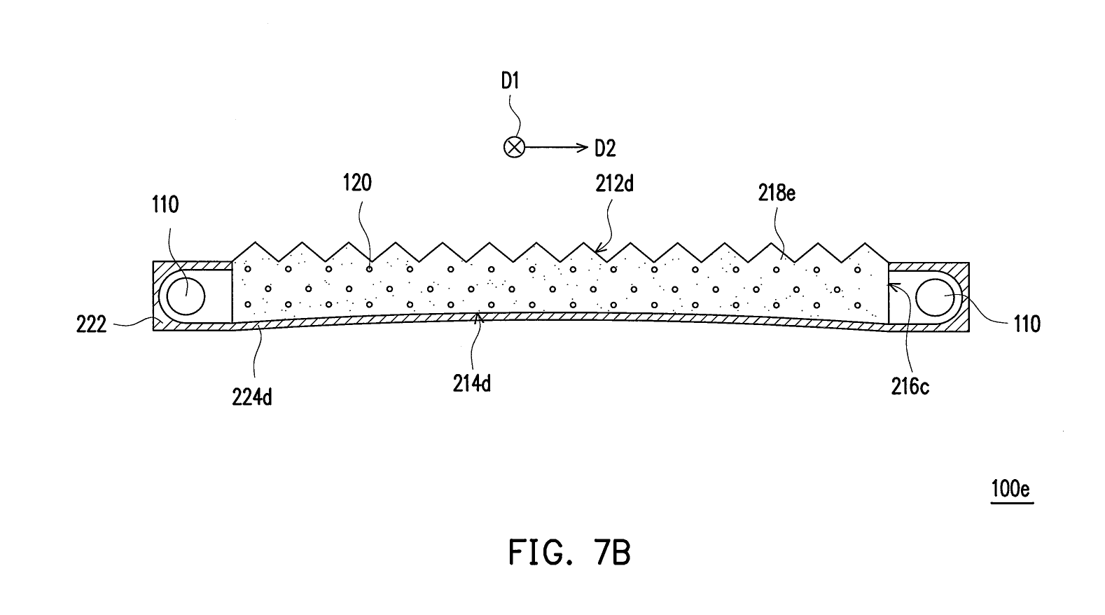

Referring to FIG. 7A and FIG. 7B, the backlight module 100e of the embodiment is similar to the backlight module 100d in FIG. 6A, the main difference between the backlight module 100e and the backlight module 100d is that the extending direction of each of the rod-shaped prism structures 218e is substantially parallel to the light incident surface 216c in the embodiment. Specifically, the extending direction of each of the rod-shaped prism structures 218e is substantially parallel to the direction D1 and substantially perpendicular to the direction D2. Moreover, the rod-shaped prism structures 218 are arranged along the direction D2. The rod-shaped prism structures 218e are capable of reducing the dispersion angle of the emitted light in the direction D2, and the rod-shaped prism structures 218 of FIG. 6A are capable of reducing the dispersion angle of the emitted light in the direction D1.

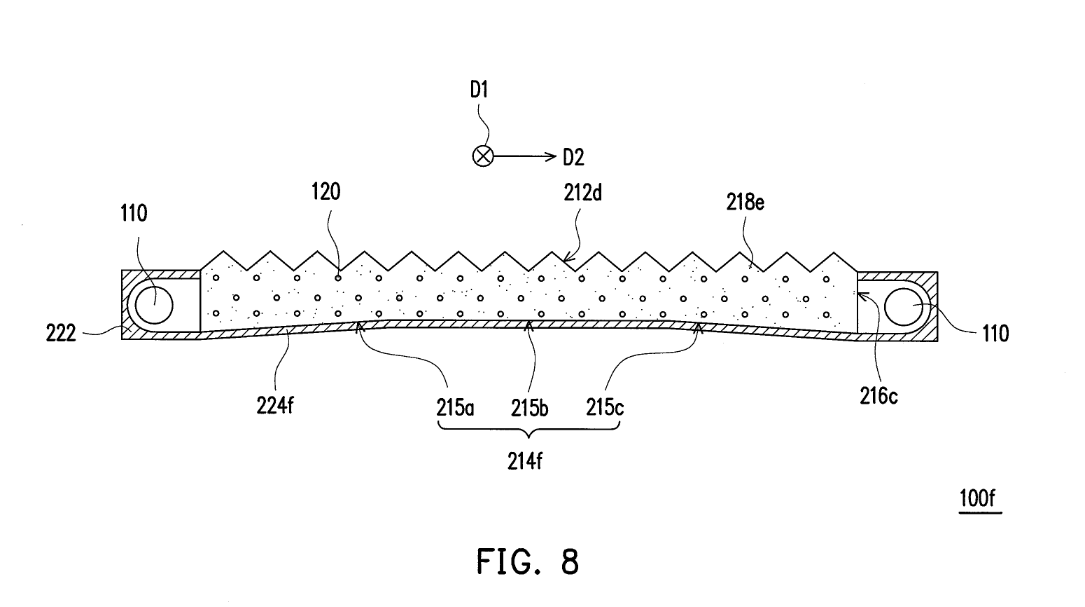

Referring to FIG. 8, the backlight module 100f of the embodiment is similar to the backlight module 100e in FIG. 7B, the main difference between the backlight module 100f and the backlight module 100e is that the boundary surface 214d in FIG. 7B is a curved surface, and the boundary surface 214f of the embodiment is a bent surface, wherein the boundary surface 214f protrudes toward the light emitting surface 212d, and the boundary surface 214f is bent in the direction substantially perpendicular to the light incident surface 216c. In the embodiment, the boundary surface 214f includes a plurality of planes 215a, 215b, and 215c, and the two neighboring planes (such as the planes 215a and 215b or the planes 215b and 215c) are connected to each other and have an included angle larger than 0 degree and smaller than 180 degrees. Moreover, the bottom portion 224f may be bent with the boundary surface 214f in the embodiment. Accordingly, the uniformity of the surface light source provided by the backlight module 100f may further be enhanced. In other embodiments, the boundary surface 214f may protrude in the direction away from the light emitting surface 212d.

The bent boundary surface 214f of the embodiment may be applied to the backlight module 100d of FIG. 6A or the backlight module in other embodiments.

To sum up, in the backlight module and the light guide unit according to the embodiments of the invention, the scattering region and the bottom portion of the reflective region are integrally formed, and no air gap is between the scattering region and the bottom portion. Accordingly, the light uniformity in the embodiments of the invention is not reduced due to the abnormal attachment of the light guide plate and the reflective plate in the backlight module, wherein the abnormal attachment is caused by the deformation of the light guide plate or the reflective plate in the related art. Therefore, the light guide unit according to the embodiments of the invention may guide light having uniform brightness on the light emitting surface, and the backlight module may provide a uniform surface light source.

Moreover, the scattering region and the bottom portion are integrally formed in the embodiments of the invention. Accordingly, the light quality in the embodiments of the invention is not reduced due to the poor surface cleanness while the light guide plate and the reflective plate are assembled in the related art. Therefore, in the embodiments of the invention, the backlight module and the light guide unit have good optical quality and high yield.

Furthermore, compared with the light guide plate, the reflective plate, and the reflective lamp cover in the related art, wherein the optical quality is reduced due to the error generated when the light guide plate, the reflective plate, and the reflective lamp are aligned, in the embodiments of the invention, the scattering region and the reflective region are integrally formed, and the scattering region and the bottom portion are integrally formed. Accordingly, while the light transmissive base has been integrally formed, each of the scattering region, the lamp cover portion, and the bottom portion is disposed in the suitable position. Therefore, the backlight module and the light guide unit of the embodiments of the invention have good optical quality and high yield.

In the conventional light guide plate, the suitable distribution design of the optical micro-structure on the surface of the light guide plate by an engineer having sufficient experience is necessary to obtain the uniform surface light source. However, designing the suitable distribution costs the company a lot of research funds and a lot of research time. Compared with the conventional light guide plate, the light guide unit and the backlight module according to the embodiments of the invention are simply required to appropriately adjust the number densities of the scattering particles and the reflective particles, and then the uniform surface light source is generated. Accordingly, the design cost and the design time of the light guide unit and the backlight module according to the embodiments of the invention are lower, and the light guide unit and the backlight module according to the embodiments of the invention have shorter time from production to market.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims.

What is claimed is:

1. A backlight module, comprising:
a light transmissive base comprising:
a scattering region having a light emitting surface, a boundary surface opposite to the light emitting surface, and a light incident surface connecting the light emitting surface and the boundary surface; and
a reflective region comprising:
a lamp cover portion disposed beside the light incident surface; and
a bottom portion disposed at one side of the boundary surface and connected with the scattering region through the boundary surface,
wherein the light transmissive base is integrally formed;
at least one light emitting device disposed between the light incident surface and the lamp cover portion, wherein the at least one light emitting device is capable of emitting a light beam;
a plurality of scattering particles doped in the scattering region; and
a plurality of reflective particles doped in the reflective region, wherein a first number density of the scattering particles in the scattering region is less than a second number density of the reflective particles in the reflective region, and the scattering region is capable of being passed through by the light beam and scattering the light beam, and the reflective region is capable of reflecting the light beam.

2. The backlight module as claimed in claim 1, wherein a containing space exists between the light incident surface and the lamp cover portion, and the at least one light emitting device is disposed in the containing space.

3. The backlight module as claimed in claim 1, wherein the light incident surface is a concave surface or a plane surface, or the light incident surface has surface micro-structures.

4. The backlight module as claimed in claim 1, wherein a volume percentage of the scattering particles relative to the scattering region ranges from 0.05% to 5%.

5. The backlight module as claimed in claim 1, wherein the scattering particles are substantially uniformly distributed in the scattering region, and the reflective particles are substantially uniformly distributed in the reflective region.

6. The backlight module as claimed in claim 1, further comprising an optical film set disposed on the light emitting surface of the scattering region, wherein the optical film set comprises at least one of a diffusion film, a brightness enhancement film, and a prism film.

7. The backlight module as claimed in claim 1, wherein the scattering region comprises a plurality of rod-shaped prism structures disposed on the light emitting surface.

8. The backlight module as claimed in claim 7, wherein each of the rod-shaped prism structures extends from one side adjacent to the light incident surface toward a place away from the light incident surface.

9. The backlight module as claimed in claim 7, wherein an extending direction of each of the rod-shaped prism structures is substantially parallel to the light incident surface.

10. The backlight module as claimed in claim 1, wherein the boundary surface is a curved surface or a bent surface.

11. The backlight module as claimed in claim 10, wherein the boundary surface protrudes toward the light emitting surface.

12. The backlight module as claimed in claim 10, wherein the boundary surface is substantially curved or bent in a direction perpendicular to the light incident surface.

13. A light guide unit, comprising:
a light transmissive base comprising:
a scattering region having a light emitting surface, a boundary surface opposite to the light emitting surface, and a light incident surface connecting the light emitting surface and the boundary surface; and
a reflective region comprising:
a lamp cover portion disposed beside the light incident surface, wherein a containing space exists between the light incident surface and the lamp cover portion; and
a bottom portion disposed at one side of the boundary surface and connected with the scattering region through the boundary surface,
wherein the light transmissive base is integrally formed;
a plurality of scattering particles doped in the scattering region; and
a plurality of reflective particles doped in the reflective region, wherein a first number density of the scattering particles in the scattering region is less than a second number density of the reflective particles in the reflective region, and the scattering region is capable of being passed through by a light beam and scattering the light beam, and the reflective region is capable of reflecting the light beam.

14. The light guide unit as claimed in claim 13, wherein the light incident surface is a concave surface or a plane surface.

15. The light guide unit as claimed in claim 13, wherein the light incident surface has surface micro-structures.

16. The light guide unit as claimed in claim 13, wherein a volume percentage of the scattering particles relative to the scattering region ranges from 0.05% to 5%.

17. The light guide unit as claimed in claim 13, wherein the scattering particles are substantially uniformly distributed in the scattering region.

18. The light guide unit as claimed in claim 13, wherein the reflective particles are substantially uniformly distributed in the reflective region.

19. The light guide unit as claimed in claim 13, wherein the scattering region comprises a plurality of rod-shaped prism structures disposed on the light emitting surface.

20. The light guide unit as claimed in claim 13, wherein the boundary surface is a curved surface or a bent surface.
